(19) United States
(12) Patent Application Publication
(10) Pub. No.: US 2025/0388731 A1
(43) Pub. Date: Dec. 25, 2025

(54) COMPOSITION FOR MANUFACTURING POLYURETHANE FOAM WITH A LOW CONTENT OF A VOLATILE ORGANIC COMPOUND, AND A METHOD OF MANUFACTURING POLYURETHANE USING SAME

(71) Applicants: HYUNDAI MOTOR COMPANY, Seoul (KR); KIA CORPORATION, Seoul (KR)

(72) Inventors: Sung Hoon Lee, Gwacheon-si (KR); Kyeong Ryul Kim, Ulsan (KR); Jun Seob Eom, Ulsan (KR); Hyun Jong Lee, Ulsan (KR); Won Jin Seo, Suwon-si (KR); Dong Hwan Kim, Daejeon (KR)

(73) Assignees: HYUNDAI MOTOR COMPANY, Seoul (KR); KIA CORPORATION, Seoul (KR)

(21) Appl. No.: 19/313,353

(22) Filed: Aug. 28, 2025

Related U.S. Application Data
(62) Division of application No. 17/469,646, filed on Sep. 8, 2021.

(30) Foreign Application Priority Data
Sep. 14, 2020 (KR) 10-2020-0117425

(51) Int. Cl. C08J 9/00; C08G 18/10; C08G 18/22; C08G 18/48; C08G 18/63; C08K 5/17; C08K 5/41

(52) U.S. Cl. CPC C08J 9/0061; C08G 18/10; C08G 18/225; C08G 18/4825; C08G 18/63; C08K 5/17; C08K 5/41; C08J 2375/08

(57) ABSTRACT

A composition for manufacturing a polyurethane foam with a low content of volatile organic compounds such as acetaldehyde, and a method of manufacturing a polyurethane foam using the same are disclosed. The composition for manufacturing the polyurethane foam includes a polyol composition having a polypropylene glycol content of 0.1 ppm or less and a propylene oxide content of 16 ppm or less, isocyanate, and a volatile organic compound (VOC) reducing agent. The method for manufacturing the polyurethane foam includes adding raw materials to a reactor to polymerize a polyol composition, removing impurities from the reactor; and obtaining the polyurethane foam from reactants from which the impurities are removed.

### CROSS REFERENCE TO RELATED APPLICATION

This application is a divisional of U.S. application Ser. No. 17/469,646, filed on Sep. 8, 2021, which claims priority to Korean Patent Application No. 10-2020-0117425, filed on Sep. 14, 2020, the entire contents of which are herein incorporated by reference in their entirety.

### BACKGROUND OF THE DISCLOSURE

### Technical Field

The present disclosure relates to a composition for manufacturing a polyurethane foam with a low content of volatile organic compounds such as acetaldehyde, and a method of manufacturing a polyurethane foam using the same.

### Description of the Related Art

The seat of a vehicle is a part that allows the occupant to sit thereon and drive the vehicle. The seat occupies most of the volume of vehicle interior materials. The seat pad included in the seat is mostly manufactured using polyurethane foam in accordance with requirements such as cushioning, resilience, economic feasibility, and mass producibility.

Polyurethane foam for a sheet is manufactured using an addition polymerization reaction between a polyol system, including a catalyst, a surfactant, a foaming agent, and isocyanate. However, volatile organic compounds (VOCs) such as benzene and toluene aldehydes are released from the manufactured polyurethane foam for a short period of time and/or continuously.

Volatile organic compounds (VOCs) are hydrocarbon compounds and are carcinogenic materials. Further, volatile organic compounds (VOCs) smell bad and cause nervous system disorders and sick-house syndrome through respiratory inhalation. Accordingly, the Ministry of Land, Infrastructure and Transport has been evaluating and managing air quality in vehicles since 2011 in order to reduce the amount of volatile organic compounds (VOCs) generated from materials and adhesives used in interior materials of new vehicles.

The Ministry of Land, Infrastructure and Transport added one new hazardous substance (acetaldehyde) to the existing seven hazardous substance management standards in 2019 to thus identify a total of eight components to be managed, thereby strengthening the standards announced by the Ministry of Land, Infrastructure and Transport (No. 2019-144).

Accordingly, all vehicle manufacturers are required to manage the quality of vehicle interior materials so as to satisfy the standards for the above eight components.

### SUMMARY OF THE DISCLOSURE

An objective of the present disclosure is to provide a polyurethane foam that is capable of satisfying laws and regulations governing volatile organic compounds by upgrading raw materials and optimizing the mixing of the raw materials including a VOC-reducing agent.

The objectives of the present disclosure are not limited to the foregoing, and other objectives are understood through the following description and realized by the compositions and methods described in the claims and combinations thereof.

A composition for manufacturing a polyurethane foam according to the present disclosure includes a polyol composition having a polypropylene glycol content of 0.1 ppm or less and a propylene oxide content of 16 ppm or less, isocyanate, and a volatile organic compound (VOC) reducing agent.

The polyol composition may have a hydroxyl value of 20 to 30 milligrams (mg) KOH/g.

The polyol composition may have a viscosity of 1,000 to 2,000 centipoise (cps) at 25° C.

The polyol composition may include at least one polyol selected from the group consisting of: a first polyol having a molecular weight of 7,000 to 8,000 g/mol, a hydroxyl value of 20 to 26 mg KOH/g, and a viscosity of 1,200 to 1,600 cps at 25° C.; a second polyol having a molecular weight of 4,000 to 5,000 g/mol, a hydroxyl value of 32 to 38 mg KOH/g, and a viscosity of 800 to 1,000 cps at 25° C.; a third polyol having a molecular weight of 5,500 to 6,500 g/mol, a hydroxyl value of 22 to 30 mg KOH/g, and a viscosity of 1,000 to 1,400 cps at 25° C.; a fourth polyol having a molecular weight of 3,500 to 4,500 g/mol, a hydroxyl value of 40 to 45 mg KOH/g, and a viscosity of 900 to 1,000 cps at 25° C.; and a combination thereof.

The polyol composition may further include a polymer of polyol (POP), and the polymer of polyol may include a polyol grafted with styrene acrylonitrile (SAN).

The VOC-reducing agent may include at least one agent selected from the group consisting of hydroxylamine, hydroxylamine sulfate, N-methylethanolamine, ethanolamine, tris (hydroxymethyl) aminomethane, and a combination thereof.

The composition for manufacturing the polyurethane foam may include 100 parts by weight of the polyol composition, 40 to 60 parts by weight of the isocyanate, and 0.1 to 2 parts by weight of the VOC-reducing agent.

The method of manufacturing a polyurethane foam according to the present disclosure includes adding raw materials to a reactor to polymerize a polyol composition, removing impurities from the reactor, and obtaining the polyurethane foam from reactants from which the impurities are removed and which contain the polyol composition, isocyanate, and a VOC-reducing agent.

In the manufacturing method, at least one fluid selected from the group consisting of CO₂, N₂, steam, distilled water, sulfuric acid, hydrochloric acid, and a combination thereof may be supplied to the reactor to remove the impurities.

In the manufacturing method, the fluid may be supplied at a flow rate of 20 to 200 kg/hr for 1 to 2 hours.

In the manufacturing method, the fluid may be supplied, the temperature of the reactor may be adjusted to 80 to 100° C., and a pressure may be adjusted to 0.5 to 1 bar.

In the manufacturing method, the fluid may be supplied to the reactor to react with the impurities, and a gas generated due to a reaction may be released to the outside, thus removing the impurities.

In the manufacturing method, after the reaction between the impurities and the fluid is completed, the pressure of the reactor may be adjusted to 0.5 to 0.97 bar, thus releasing the gas to the outside.

According to the present disclosure, it is possible to obtain a polyurethane foam that is capable of satisfying laws and regulations governing volatile organic compounds by upgrading raw materials and optimizing the mixing of the raw materials including a VOC-reducing agent.

The effects of the present disclosure are not limited to the foregoing and should be understood to include all effects that can be reasonably anticipated from the following description.

### DETAILED DESCRIPTION OF THE DISCLOSED EMBODIMENTS

The above and other objectives, features, and advantages of the present disclosure should be more clearly understood from the following embodiments. However, the present disclosure is not limited to the embodiments disclosed herein and may be modified into different forms. These embodiments are provided to thoroughly explain the disclosure and to sufficiently transfer the spirit of the present disclosure to those skilled in the art.

While terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

The terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it should be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

It is known that the cause of the release of acetaldehyde from a polyurethane foam is that impurities generated during polyol polymerization cause side reactions with isocyanate to directly become acetaldehyde, or the product is chemically decomposed due to exposure to high temperatures or ultraviolet rays, thus generating acetaldehyde.

In the present disclosure, a stripping process is added during polymerization of a polyol composition in order to remove impurities from the polyol composition, which may be a direct cause of the production of acetaldehyde. Further, in the present disclosure, a VOC-reducing agent is added as a raw material of the composition for manufacturing the polyurethane foam, thus reducing the amount of acetaldehyde that is released.

Hereinafter, the present disclosure is described with reference to specific details thereof.

A method of manufacturing a polyurethane foam according to the present disclosure includes adding raw materials to a reactor to polymerize a polyol composition, removing impurities from the reactor, and obtaining the polyurethane foam from reactants from which the impurities are removed and which contain the polyol composition, isocyanate, and a VOC-reducing agent.

The raw materials are not particularly limited. Examples of the raw materials may include ethylene glycol, diethylene glycol, dipropylene glycol, glycerin, trimethylol propane, ethylene diamine, triethanolamine, toluene diamine, sorbitol, and sucrose.

The polyol composition may be manufactured by polymerizing the raw materials. For example, a chain extension material such as ethylene oxide and propylene oxide, and a catalyst such as potassium hydroxide (KOH) and cesium hydroxide (CsOH) may be added to the raw materials and then reacted to thus obtain the polyol composition.

The polymerization time of the polyol composition is not particularly limited. For example, the polymerization time may be a time sufficient for the raw materials to react sufficiently, and the polymerization may be performed for about 20 to 35 hours.

Thereafter, the impurities are removed from the polyol composition polymerized as above. Specifically, at least one fluid selected from the group consisting of carbon dioxide (CO₂), nitrogen (N₂), steam, distilled water, sulfuric acid, hydrochloric acid, and a combination thereof may be supplied to the reactor, thus removing the impurities. The fluid is supplied to the reactor, so that the impurities generated in the polymerization process of the polyol composition react with the fluid and the products thereof are volatilized.

The fluid may be supplied at a flow rate of 20 to 200 kg/hr for 1 to 2 hours. However, the flow rate and supply time of the fluid may be adjusted appropriately depending on the size of the reactor and the amount of the raw materials.

The fluid may be supplied, the temperature of the reactor may be adjusted to 80 to 100° C., and the pressure may be adjusted to 0.5 to 1 bar, so that the fluid reacts with the impurities and the resultant material is volatilized.

After the reaction between the impurities and the fluid is completed, the pressure of the reactor may be adjusted to 0.5 to 0.97 bar so that the volatilized resultant material is released to the outside, thus being removed.

Thereafter, moisture may be removed from the polyol composition, from which the impurities have been removed, through a dehydration process, and then the polyol composition may be transferred to a storage tank for storage. The storage temperature of the polyol composition may be 50 to 70° C. However, the polyol composition may be directly transferred to a subsequent stage to manufacture a polyurethane foam without being stored.

The polyol composition, from which the impurities have been removed, obtained as described above has the following characteristics.

The polyol composition may have a polypropylene glycol (PPG) content of 0.1 ppm or less and a propylene oxide (PO) content of 16 ppm or less.

The lower limits of the contents of the polypropylene glycol and propylene oxide are not particularly limited, and each may be, for example, more than 0 ppm.

Because the above-described polyol composition has a lower content of polypropylene glycol (PPG) and propylene oxide (PO) than the conventional one, the amount of acetaldehyde released due to side reactions during the subsequent reaction with isocyanate is reduced.

Meanwhile, the polyol composition may have a hydroxyl value of 20 to 30 mg KOH/g and a viscosity of 1,000 to 2,000 cps at 25° C.

Because the polyol composition has a hydroxyl value and a viscosity equivalent to the conventional one, the physicochemical properties of the polyurethane foam manufactured using the polyol composition are the same as or similar to those of the conventional one.

The polyol composition may include at least one polyol selected from the group consisting of a first polyol, a second polyol, a third polyol, a fourth polyol, and a combination thereof under the following conditions.

The first polyol is a polyol having a molecular weight of 7,000 to 8,000 g/mol, a hydroxyl value of 20 to 26 mg KOH/g, and a viscosity of 1,200 to 1,600 cps at 25° C.

The second polyol is a polyol having a molecular weight of 4,000 to 5,000 g/mol, a hydroxyl value of 32 to 38 mg KOH/g, and a viscosity of 800 to 1,000 cps at 25° C.

The third polyol is a polyol having a molecular weight of 5,500 to 6,500 g/mol, a hydroxyl value of 22 to 30 mg KOH/g, and a viscosity of 1,000 to 1,400 cps at 25° C.

The fourth polyol is a polyol having a molecular weight of 3,500 to 4,500 g/mol, a hydroxyl value of 40 to 45 mg KOH/g, and a viscosity of 900 to 1,000 cps at 25° C.

However, the present disclosure is characterized in that the content of polypropylene glycol (PPG) and propylene oxide (PO), causing the generation of acetaldehyde from the polyol composition, which is a combination of polyols, as described above, is reduced. Therefore, although the specific combinations and mixing ratios of the polyols are somewhat changed, it should be considered that they fall within the scope of the present disclosure if the characteristics of the present disclosure are satisfied.

Meanwhile, the polyol composition may further include a polymer of polyol (POP). The polymer of polyol (POP) is a constitution for improving the hardness of the polyurethane foam. The type thereof is not particularly limited, but examples thereof may include a polyol grafted with styrene acrylonitrile (SAN).

The content of the polymer of polyol (POP) may be 30 wt. % or less based on the total weight of the polyol composition. When the content of the polymer of polyol (POP) is more than 30 wt. %, because the hardness of the polyurethane foam becomes very high, occupants may complain of uncomfortable seats.

Finally, the polyurethane foam may be obtained from the reactants containing the polyol composition from which the impurities have been removed, the isocyanate, and the VOC-reducing agent.

The type of isocyanate is not particularly limited. Examples thereof may include aromatic isocyanate (e.g., toluene diisocyanate) and/or aliphatic isocyanate (e.g., hexamethylene diisocyanate).

In the present disclosure, the VOC-reducing agent is applied to the composition for manufacturing the polyurethane foam, thereby preventing the generation of acetaldehyde due to the unreacted materials of the polyol composition which have not been removed.

The VOC-reducing agent serves to reduce the release of formaldehyde and acrolein. Specifically, the VOC-reducing agent may have a liquid form, and may include a compound having an amine group, an antioxidant, a surfactant, and a solvent having a hydroxyl group.

In order to increase the efficiency with which acetaldehyde is reduced, a hydroxyl-based amine may be used as the compound having the amine group. The hydroxyl-based amine may have excellent reactivity under an alkaline condition and may be bonded to an aldehyde compound to be converted into oxime, so that the efficiency with which aldehyde is reduced is capable of being maximized during urethane synthesis.

The hydroxyl-based amine may include at least one amine selected from the group consisting of hydroxylamine, hydroxylamine sulfate, N-methylethanolamine, ethanolamine, tris(hydroxymethyl)aminomethane, and a combination thereof.

The reactants of the polyurethane foam may include 100 parts by weight of the polyol composition, 40 to 60 parts by weight of the isocyanate, and 0.1 to 2 parts by weight of the VOC-reducing agent.

When the content of the VOC-reducing agent is more than 2 parts by weight, the highly reactive VOC-reducing agent may participate in the urethane reaction, which may cause non-molding or deterioration of the rigidity of the polyurethane foam.

The reactants may further include additives such as a catalyst, a surfactant, and a foaming agent.

Hereinafter, the present disclosure is described in more detail based on Examples, but the present disclosure is not limited by the following Examples.

### Example 1, Example 2, Comparative Example 1, and Comparative Example 2

The composition for manufacturing the polyurethane foam was prepared based on the composition according to the following Table 1.

TABLE 1

| | Classification | | | |
|---|---|---|---|---|
| | | | Compara- | Compara- |
| | Example | Example | tive | tive |
| Component | 1 | 2 | Example 1 | Example 2 |
| Polyol Composition 1 | 100 | 70 | — | — |
| [parts by weight] | | | | |
| Polyol Composition 2 | — | — | 100 | 70 |
| [parts by weight] | | | | |
| Polymer of polyol | — | 30 | — | 30 |
| [parts by weight] | | | | |
| Isocyanate [parts | 48.1 | 53.6 | 48.1 | 53.6 |
| by weight] | | | | |
| VOC-reducing agent | 2 | 2 | 0 | 0 |
| [parts by weight] | | | | |
| Surfactant [parts | 1.5 | 1.5 | 1.5 | 1.5 |
| by weight] | | | | |
| Catalyst [parts by | 2.1 | 2.1 | 2.1 | 2.1 |
| weight] | | | | |
| Foaming agent | 3.8 | 3.8 | 3.8 | 3.8 |
| [parts by weight] | | | | |

In Table 1, the Polyol Composition 1 was subjected to an impurity removal process according to the present disclosure, and the Polyol Composition 2 was not.

Each composition was subjected to foaming as follows, thus manufacturing a polyurethane foam for a sheet.

Each composition was injected into the lower part of a mold. When the injection was completed, the top plate of the mold was closed, and curing was performed at a mold temperature of 55 to 65° C. for 4 to 6 minutes. The polyurethane foam was demolded from the mold and then stabilized at 25° C. for 12 hours or more under a condition of 50 RH %.

Each of physical properties of the polyurethane foam manufactured as above was measured as follows.

### Experimental Example 1—Foaming Properties

Settling and rising times were measured in order to check the difference in foaming properties of the compositions according to Examples 1 and 2 and Comparative Examples 1 and 2.

“Settling” refers to a reduction ratio between the maximum height obtained through free foaming of the polyurethane foam and the reduction in height due to the release of carbon dioxide from the polyurethane foam to the outside.

The rising time is the time taken for the foaming reaction of the polyurethane foam to complete, which is related to the chemical reaction rate of the polyurethane foam.

The above-described foaming properties affect the properties of the final product.

The results are shown in the following Table 2.

TABLE 2

| | Classification | | | |
|---|---|---|---|---|
| Measurement | | | Comparative | Comparative |
| index | Example 1 | Example 2 | Example 1 | Example 2 |
| Settling [%] | 13.2 | 15.1 | 12.4 | 16.5 |
| Rise time [sec] | 102 | 91 | 100 | 93 |

Referring to Table 2, the foaming properties of the Examples are similar to those of the Comparative Examples. Therefore, it can be indirectly confirmed that the physicochemical properties of the final product will not be changed even when the polyol composition subjected to the impurity removal process as in the present disclosure is used.

### Experimental Example 2—Physicochemical Properties

The hardness and the permanent compression shrinkage of the polyurethane foams manufactured using the compositions according to Examples 1 and 2 and Comparative Examples 1 and 2 were measured. The results are shown in the following Table 3.

TABLE 3

| | Classification | | | |
|---|---|---|---|---|
| Measurement | | | Comparative | Comparative |
| index | Example 1 | Example 2 | Example 1 | Example 2 |
| Hardness [kgf] | 17.4 | 28.6 | 71.4 | 28.6 |
| Permanent | 18.5 | 11.1 | 17.2 | 11.3 |
| compression | | | | |
| shrinkage [%] | | | | |

Referring to Table 3, the hardness and permanent compression shrinkage of each polyurethane foam of the Examples are the same as or similar to the hardness and permanent compression shrinkage of each Comparative Example. Therefore, it can be seen that the properties required for the final product are capable of being maintained even when the polyol composition subjected to the impurity removal process is used and reactants to which the VOC-reducing agent is added are used, as in the present disclosure.

### Experimental Example 3—Amount of Released Aldehyde

The amount of aldehyde released from the polyurethane foams manufactured using the compositions according to Examples 1 and 2 and Comparative Examples 1 and 2 was measured as follows.

Each of the polyurethane foams was put into a 1 m3 chamber that satisfied the test conditions of KS I ISO 12219-4 ‘Indoor air for vehicles-Part 4: Method of measuring volatile organic compounds released from vehicle interior parts-Small chamber method’. The polyurethane foams were allowed to stand for about 2 hours under conditions of a chamber temperature of about 65° C. and a relative humidity of about 5%. The air in the chamber was adsorbed onto a DNPH (dinitrophenylhydrazine) cartridge. The amount of aldehyde components released was analyzed using HPLC analysis.

The results are shown in the following Table 4.

TABLE 4

| | Classification | | | |
|---|---|---|---|---|
| Measurement | | | Comparative | Comparative |
| index [μg/m³] | Example 1 | Example 2 | Example 1 | Example 2 |
| Acetaldehyde | 388 | 518 | 2,239 | 2,919 |
| Formaldehyde | 12 | 15 | 494 | 564 |
| Acrolein | 26 | 27 | 133 | 121 |

Referring to Table 4, the amount of aldehyde compounds, (e.g., acetaldehyde, formaldehyde, and acrolein), released from the polyurethane foams of the Examples was greatly 5 reduced. In comparison of Example 1 and Comparative Example 1, release of acetaldehyde was reduced by 83%, formaldehyde by 98%, and acrolein by 80%. Therefore, it can be seen that the use of the polyol composition subjected to the impurity removal process and the use of the reactants to which the VOC-reducing agent is added as in the present disclosure greatly reduce the amount of acetaldehyde that is released from the polyurethane foam.

Although specific embodiments of the present disclosure have been described herein, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. A method of manufacturing a polyurethane foam, the method comprising:
adding raw materials to a reactor to polymerize a polyol composition;
removing impurities from the reactor; and
obtaining the polyurethane foam from reactants from which the impurities are removed and which contain the polyol composition, isocyanate, and a volatile organic compound (VOC) reducing agent, the polyol composition having a polypropylene glycol content of 0.1 ppm or less and a propylene oxide content of 16 ppm or less.

2. The method of claim 1, further comprising:
supplying at least one fluid to the reactor to remove the impurities,
wherein the at least one fluid is selected from the group consisting of CO₂, N₂, steam, distilled water, sulfuric acid, hydrochloric acid, and a combination thereof.

3. The method of claim 2, wherein the at least one fluid is supplied at a flow rate of 20 to 200 kg/hr for 1 to 2 hours.

4. The method of claim 2, wherein, when the at least one fluid is supplied, a temperature of the reactor is adjusted to 80 to 100° C., and a pressure is adjusted to 0.5 to 1 bar.

5. The method of claim 2, wherein the at least one fluid supplied to the reactor reacts with the impurities and generates a gas, and
wherein the gas is released outside of the reactor, thus removing the impurities.

6. The method of claim 5, wherein, following the reaction between the impurities and the at least one fluid, a pressure of the reactor is adjusted to 0.5 to 0.97 bar, thus releasing the gas to the outside.
